(19) United States
(12) Patent Application Publication
(10) Pub. No.: US 2026/0093199 A1
(43) Pub. Date: Apr. 2, 2026

(54) STRUCTURE IN VICINITY OF DISCHARGE PORT OF SHEET IN IMAGE FORMING APPARATUS

(71) Applicant: CANON KABUSHIKI KAISHA, Tokyo (JP)

(72) Inventor: NAOKI YANOKURA, Ibaraki (JP)

(21) Appl. No.: 19/339,449

(22) Filed: Sep. 25, 2025

(30) Foreign Application Priority Data
Oct. 2, 2024 (JP) 2024-173480

(51) Int. Cl. G03G 15/00; G03G 21/16; G03G 21/20

(52) U.S. Cl. CPC G03G 15/6552; G03G 21/1604; G03G 21/206

(57) ABSTRACT

A cover unit is provided above a discharge port and protrudes so as to cover a part of a holding unit. A guide unit includes a bending point and guides a sheet discharged from the discharge port to the holding unit. The cover unit includes a connecting portion, a ceiling surface protruding toward the connecting portion from above the discharge port, and a wall surface. A photosensitive member is disposed below a straight line passing through a lower end of the wall surface and a lower edge of the discharge port. A distance from the bending point of the guide unit to a leading end of the guide unit is longer than a distance from the bending point to the lower end of the wall surface of the cover unit.

### BACKGROUND

### Field of the Technology

The present disclosure relates to a structure in a vicinity of a discharge port of a sheet in an image forming apparatus.

### Description of the Related Art

An image forming apparatus using an electrophotographic scheme forms an electrostatic latent image by irradiating a photosensitive member with light, and develops the electrostatic latent image with toner to form a toner image. Therefore, when the photosensitive member is irradiated with stray light, a quality of the toner image deteriorates. In order to reduce a size of the image forming apparatus, the photosensitive drum may be disposed close to a discharge port of a sheet. As a result, it is more prone to the effects of the stray light than in the past. According to Japanese Patent Laid-Open No. 2022-118777, there has been proposed an eave portion for reducing an amount of light entering the inside of the image forming apparatus from the discharge port.

In order to achieve further reduction of the size of the image forming apparatus, the photosensitive drum must be further installed near the discharge port. In this case, a larger eave portion is required, and the sheet may be caught in the eave portion.

### SUMMARY

The disclosure provides an image forming apparatus comprising: a photosensitive member that is rotationally driven; a charging unit that charges a surface of the photosensitive member; a light irradiation unit that irradiates the photosensitive member with light to form an electrostatic latent image; a developing unit that develops the electrostatic latent image using toner to generate a toner image; a transfer unit that transfers the toner image from the photosensitive member to a sheet; a fixing unit that fixes the toner image onto the sheet; a discharge unit that discharges the sheet from a discharge port; a holding unit that holds the sheet discharged from the discharge port; a cover unit provided above the discharge port and protruding so as to cover a part of the holding unit; and a guide unit that includes a bending point and guides the sheet discharged from the discharge port to the holding unit. The cover unit includes: a connecting portion; a ceiling surface protruding toward the connecting portion from above the discharge port; and a wall surface protruding from the connecting portion so as to approach the holding unit. The photosensitive member is disposed below a straight line passing through a lower end of the wall surface and a lower edge of the discharge port. A distance from the bending point of the guide unit to a leading end of the guide unit is longer than a distance from the bending point to the lower end of the wall surface of the cover unit.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is an external perspective view of an image forming apparatus.

FIG. 2 is a simplified sectional view of the image forming apparatus.

FIGS. 3A and 3B are simplified sectional views illustrating a discharge port, a pressing member and an eave member.

FIGS. 4A and 4C are simplified sectional views illustrating a discharge port, a pressing member and an eave member.

FIG. 5 is a simplified sectional views illustrating a discharge port and an eave member.

FIG. 6 is an external perspective view of an image forming apparatus.

FIG. 7 is a simplified sectional views illustrating a discharge port and an eave member.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### 1. Structure of Image Forming Apparatus

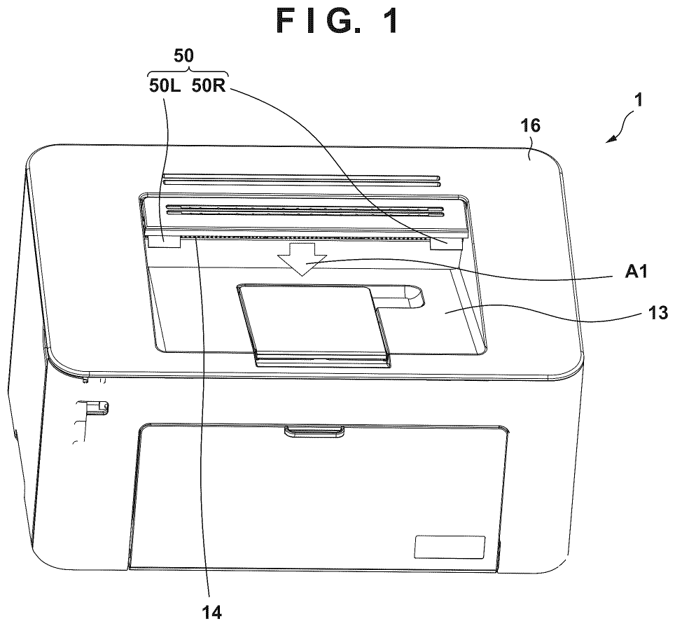

FIG. 1 shows an image forming apparatus 1. The image forming apparatus 1 forms an image on a recording medium (sheet) by executing an electrophotographic process. An upper surface cover 16 is an upper surface member that forms the upper surface of a housing of the image forming apparatus 1. A discharge tray 13 is provided in the central of the upper surface of the image forming apparatus 1. A discharge port 14 is an opening that communicates with the inside of the image forming apparatus 1. A sheet pressing member 50 is disposed at the discharge port 14, and guides the sheet on which a toner image is formed, and which is discharged from the discharge port 14, onto the discharge tray 13. In FIG. 1, the sheet pressing member 50 includes a first pressing member 50L and a second pressing member 50R. The first pressing member 50L is disposed at one end portion in a width direction of the discharge port 14 perpendicular to a sheet discharge direction A1. The second pressing member 50R is disposed at the other end portion in the width direction. The structures of the first pressing member 50L and the second pressing member 50R are the same or similar. Therefore, the first pressing member 50L and the second pressing member 50R will be described below as the sheet pressing member 50. The sheet pressing member 50 protrudes toward a downstream side of the sheet discharge direction A1. The two sheet pressing members 50 press the vicinity of one end portion and the vicinity of the other end portion in the width direction of the sheet discharged from the discharge port 14. Accordingly, it improves the alignment and stacking of the sheets on the discharge tray 13.

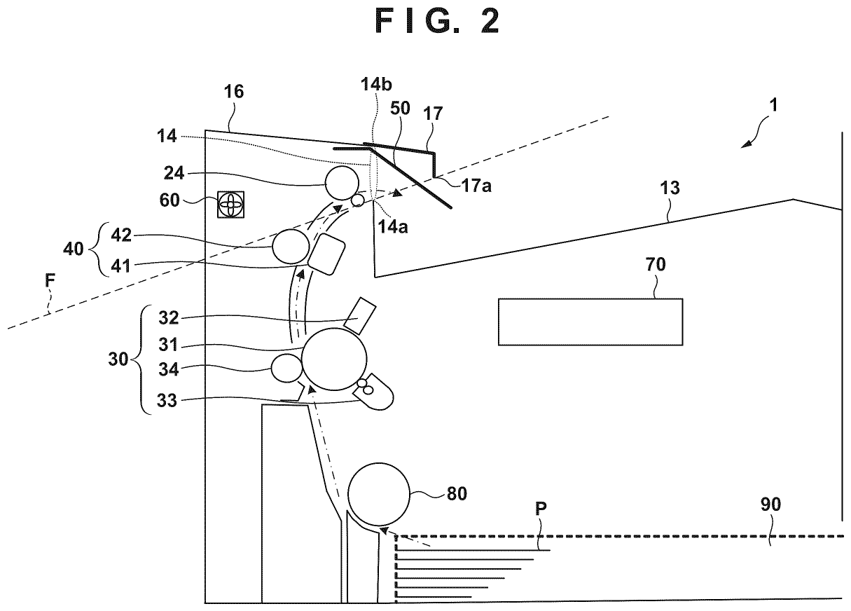

FIG. 2 is a cross-sectional view of the image forming apparatus 1. The feed cassette 90 is a storage for holding a plurality of sheets P. The feeding roller 80 feeds a single sheet P out of the plurality of sheets P stacked on the feed cassette 90 to the image forming unit 30.

The image forming unit 30 includes a photosensitive member 31, a charging member 32, a developing member 33, and a transfer member 34. The photosensitive member 31 is a drum-shaped image carrier (for example, a photosensitive drum) that is rotationally driven by a motor or the like. The charging member 32 is a charging roller or a discharging wire that uniformly charges the surface of the rotating photosensitive member 31. The laser scanner 70 is an exposure apparatus or an exposure light source (light irradiation unit) that irradiates the surface of the photosensitive member 31 with light corresponding to image data to form an electrostatic latent image. The laser scanner 70 may be realized by a light-emitting diode (e.g., an organic EL light-emitting device). EL is an abbreviation for electroluminescence. The developing member 33 is a developing roller or a developing sleeve that forms a toner image by adhering the toner to the photosensitive member 31. The transfer member 34 is a transfer roller or a transfer blade that transfers a toner image from the photosensitive member 31 to the sheet P. As the photosensitive member 31 rotates, the sheet P is further conveyed to the downstream side in the conveyance direction of the sheet P. Here, the conveyance direction is a direction from the feed cassette 90 toward the discharge port 14.

The fixing device 40 is a fixing member having a pressure roller 42 and a heating film 41 as two rotating bodies. The heating film 41 applies heat to the toner image and the sheet P, and the pressure roller 42 presses the toner image against the sheet P, whereby the toner image is fixed on the sheet P. The fixing device 40 conveys the sheet P to the discharge roller pair 24 along a sheet guide 43. The sheet guide 43 may be coated with a light shielding paint for reducing stray light. A fan for cooling the inside of the image forming apparatus 1 or discharging water vapor generated therein may be provided near the fixing device 40.

The discharge roller pair 24 conveys the sheet P and discharges the sheet P from the discharge port 14 onto the discharge tray 13. The sheet pressing member 50 is an example of a guide unit that guides the sheet P to the discharge tray 13.

The discharge port 14 is a rectangular opening extending along the width of the sheet P, and has an upper edge 14b and a lower edge 14a. The upper edge 14b and the lower edge 14a correspond to the two long sides of the rectangular opening.

The cave member 17 extends from the upper edge 14b generally along the discharge direction A1. The cave member 17 covers a part of the discharge tray 13. The vicinity of the leading end of the cave member 17 is bent in the downward direction. A straight line F extends a line segment connecting the leading end 17a and the lower edge 14a of the cave member 17. The position of the leading end 17a is designed so that the straight line F passes above the photosensitive member 31. That is, the photosensitive member 31 is disposed below the straight line F passing through the lower end (leading end 17a) of the wall surface of the cave member 17 and the lower edge 14a of the discharge port 14. Accordingly, entry of stray light (external light) that is to be directed to the photosensitive member 31 through the discharge port 14 is suppressed.

### 2. Relationship Between Discharge Port, Sheet Pressing Member, and Cave Member

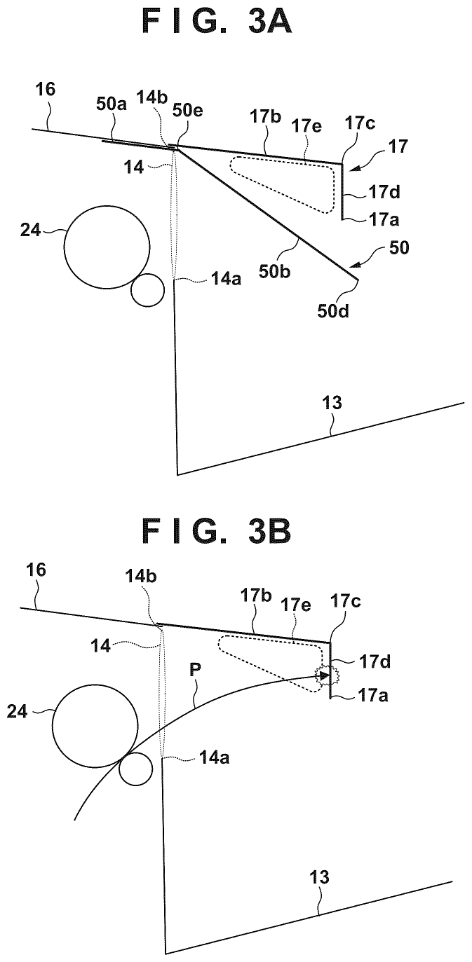

The FIG. 3A shows a detailed view of the cave member 17 and the sheet pressing member 50. The upper edge 14b of the discharge port 14 is present at the end portion of the upper surface cover 16. The upper surface cover 16 and the cave member 17 may be integrated.

The sheet pressing member 50 is formed of a single sheet material having flexibility. The sheet pressing member 50 is bent with the bending point 50e as a boundary. The sheet pressing member 50 includes a fixing part 50a and a pressing portion 50b. There is a bending point 50e between the fixing part 50a and the pressing portion 50b. The fixing part 50a is fixed to the rear surface of the upper surface cover 16 forming the upper portion of the discharge port 14. That is, the fixing part 50a is fixed to the upper surface member of the image forming apparatus 1. The pressing portion 50b is started from the bending point 50c. The pressing portion 50b is disposed at an angle such that it tilts downward from the horizontal direction. The leading end 50d of the pressing portion 50b is positioned below the bending point 50e in the vertical direction. The pressing portion 50b is an example of a movable portion that is connected at the bending point 50c to the fixing part 50a and rotates with the bending point 50e as a rotation axis. Alternatively, the pressing portion 50b is an example of a movable portion that is pushed by the sheet P discharged from the discharge port 14 and moves away from the discharge port 14, and returns to a standby position when the sheet P is separated from the leading end 50d of the sheet pressing member 50. That is, the sheet pressing member 50 is elastically deformable.

The cave member 17 is an example of a cover unit provided above the discharge port 14 and protruding so as to cover a part of the discharge tray 13. The cave member 17 may further function as a reduction unit or a light shielding unit that reduces external light entering from the discharge port 14 and going to the photosensitive member 31. The cave member 17 has an upper surface member 17b and a wall member 17d. The upper surface member 17b is an example of a ceiling surface (roof part) protruding from above the discharge port 14 toward the bending portion 17c. The wall member 17d is an example of a wall surface protruding from the bending portion 17c so as to approach the discharge tray 13. The upper surface member 17b, the wall member 17d, and the bending portion 17c are coupled to each other at the boundary. The bending portion 17c may be referred to as a connecting portion. The wall member 17d functions as an external light reducing member or a light shielding member. The external light is background light emitted from a light source existing outside the image forming apparatus 1.

As shown in the FIG. 3B, a space 17e occurs below the upper surface member 17b and on the side of the wall member 17d. Assuming that there is no sheet pressing member 50, the leading end of the sheet P discharged from the discharge port 14 collides with the wall member 17d. As a result, the sheet P is bent or the sheet P is clogged in the vicinity of the discharge port 14. As illustrated in FIG. 3A, the sheet pressing member 50 guides the sheet P that is to be directed toward the wall member 17d across the space 17e to the discharge tray 13. When the discharge direction of the sheet P is appropriately regulated, the sheet P is prevented from being caught by the wall member 17d.

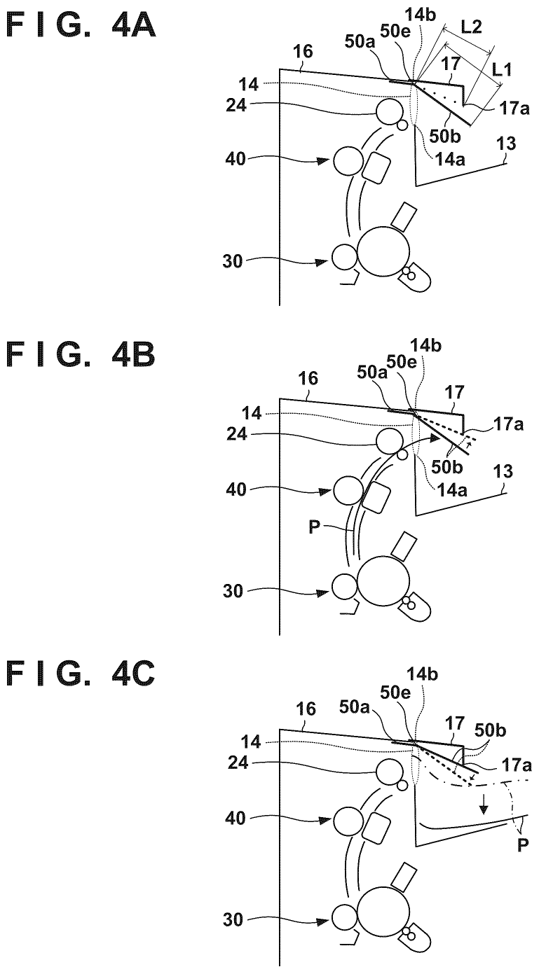

As illustrated in FIG. 4A, a distance L1 is a distance from the leading end 50d downstream side of the pressing portion 50b of the sheet pressing member 50 to the bending point 50c. A distance L2 is a distance from the bending point 50e to the leading end 17a of the cave member 17. In the first embodiment, the distance L1 is greater than the distance L2.

As shown in FIG. 4B, the sheet P discharged from the discharge port 14 is pressed by the sheet pressing member 50, but the sheet pressing member 50 is also pressed by the sheet P. Accordingly, the sheet pressing member 50 is deformed. The sheet pressing member 50 gradually approaches the leading end 17a of the cave member 17. The deformation of the sheet pressing member 50 is completed prior to the sheet pressing member 50 colliding with or at colliding with the leading end 17a of the cave member 17. The deformation amount of the sheet pressing member 50 may depend on a basis weight of the sheet P.

The sheet pressing member 50 is designed with a thickness and a hardness that allow the sheet pressing member 50 to bend upon the sheet P coming into contact with the sheet pressing member 50. The sheet pressing member 50 is bent until the sheet P comes into contact with the sheet pressing member 50 and the sheet pressing member 50 comes into contact with the leading end 17a of the wall member 17d. Here, the basis weight of the sheet P is, for example, equal to or greater than 60 g/m² and equal to or less than 220 g/m². Here, m² is an abbreviation for square meter. The basis weight of the sheet P is, for example, a basis weight of the sheet P, which can be formed with an image by the image forming apparatus 1, is described in an instruction manual or a specification table of the image forming apparatus 1. The thickness of the sheet P may be, for example, equal to or greater than 0.05 mm and equal to or less than 0.3 mm. Note that these values are merely examples.

As shown in FIG. 4C, the sheet pressing member 50 is deformed, so that the sheet P discharged from the discharge port 14 does not collide with the cave member 17 and is appropriately discharged. When the sheet pressing member 50 is restored, the sheet P is pressed in the vertical direction and is appropriately guided onto the discharge tray 13.

According to the first embodiment, the photosensitive member 31 is disposed below the straight line F. Further, the distance L1 from the bending point 50e of the sheet pressing member 50 to the leading end 50d is longer than the distance L2 from the bending point 50e to the leading end 17a of the wall member 17d. Accordingly, entry of stray light that is to be directed to the photosensitive member 31 through the discharge port 14 is reduced or blocked. Further, the sheet P discharged from the discharge port 14 is less likely to be caught by the wall member 17d. As a result, further reduction of the size of the image forming apparatus 1 is achieved.

The sheet pressing member 50 rotates about the bending point 50e as a rotation center or is pushed by the sheet P to move. Accordingly, the sheet pressing member 50 may press the sheet P downward with an appropriate pressing force to guide the sheet P to the discharge tray 13.

There is a possibility that the sheet P collides with the wall member 17d when a space 17e occurs below the upper surface member 17b and on the side of the wall member 17d. However, when the sheet pressing member 50 having the properties described above is employed, the sheet P is less likely to collide with the wall member 17d.

According to the first embodiment, since the sheet pressing member 50 has flexibility, the sheet pressing member 50 is elastically deformable. However, when the sheet pressing member 50 is touched by the user, the sheet pressing member 50 may be plastically deformed or dirty. According to the first embodiment, the cave member 17 may make it difficult for the user to touch the sheet pressing member 50. As a result, the soundness of the sheet pressing member 50 will be maintained.

The sheet pressing member 50 is designed with a thickness and a hardness that allow the sheet pressing member 50 to bend upon the sheet P coming into contact with the sheet pressing member 50. Accordingly, the sheet pressing member 50 can appropriately guide the sheet P to the discharge tray 13. Here, the basis weight of the sheet P may be, for example, equal to or greater than 60 g/m² and equal to or less than 220 g/m². The thickness of the sheet P may be, for example, equal to or greater than 0.05 mm and equal to or less than 0.3 mm.

The sheet pressing member 50 may include at least one pressing member (e.g., a first pressing member 50L and a second pressing member 50R) that presses the sheet P discharged from the discharge port 14. The first pressing member 50L and the second pressing member 50R may be disposed at both ends of the discharge port 14. Accordingly, the sheet pressing member 50 can stably guide the sheet P to the discharge tray 13. In addition, there may be a margin region where an image is not formed at both ends of the sheet P. Therefore, the margin region comes into contact with the sheet pressing member 50. Accordingly, the sheet pressing member 50 is less likely to be contaminated by the toner. Further, dirt adhering to the sheet pressing member 50 may be less likely to be transferred to an image on the sheet P.

### Second Embodiment

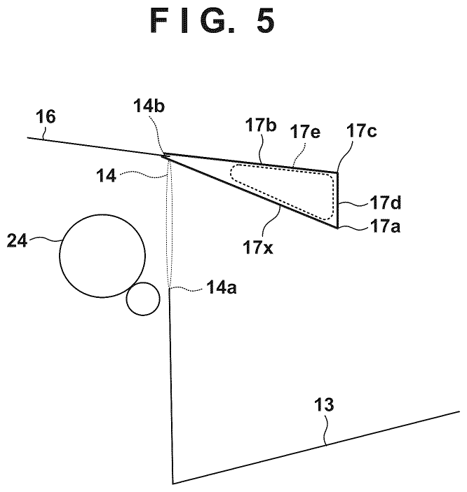

FIG. 5 shows an cave member 17 of the second embodiment. The cave member 17 has a lower face plate 17x. The lower face plate 17x prevents the sheet P from colliding with the wall member 17d. The lower face plate 17x is shaped, sized, and made so as to prevent the entry of the sheet P into the space 17e described above. In FIG. 5, the lower face plate 17x extends from the upper edge 14b of the discharge port 14 to the leading end 17a of the cave member 17 and covers the space 17e. Note that these are merely examples. The lower face plate 17x may cover the vicinity of the leading end 17a of the cave member 17, since it is enough to prevent the sheet P from colliding with the wall member 17d. That is, one end portion of the lower face plate 17x may be coupled to the leading end 17a of the cave member 17, and the other end portion of the lower face plate 17x may be coupled to the upper surface member 17b.

According to the second embodiment, the cave member 17 reduces or blocks light that is going from the discharge port 14 to the photosensitive member 31. Further, a lower face plate 17x is employed which is connected to the leading end 17a of the wall member 17d and guides the sheet P discharged from the discharge port 14 to the discharge tray 13. Accordingly, the sheet P discharged from the discharge port 14 is less likely to be caught by the wall member 17d. As a result, further reduction of the size of the image forming apparatus 1 is achieved. Further, the cave member 17 may make it difficult for the user to touch the sheet pressing member 50.

The lower face plate 17x may be connected to the upper edge 14b or the upper surface member 17b of the discharge port 14. Alternatively, the lower face plate 17x may be connected or fixed to the rear face of the upper surface cover 16.

### Third Embodiment

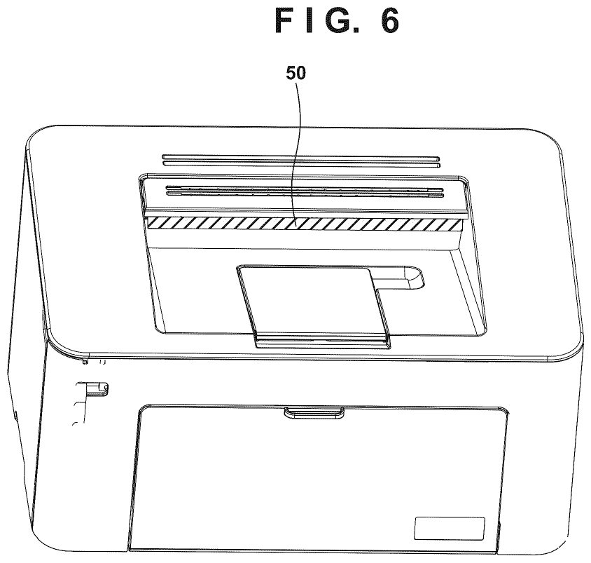

FIG. 6 shows another example of the sheet pressing member 50. According to FIG. 1, the first pressing member 50L and the second pressing member 50R are respectively disposed at one end portion and the other end portion of the discharge port 14 in the width direction of the sheet P. This is advantageous for reducing the material of the sheet pressing member 50. The sheet pressing member 50 of the third embodiment shown in FIG. 6 is formed of a single sheet material extending from one end portion to the other end portion in the width direction of the discharge port 14. Further, the sheet pressing member 50 may be formed of a sheet material having a light shielding property. For example, the sheet pressing member 50 is coated in black or molded with a black resin. Accordingly, the sheet pressing member 50 may reduce the entry of external light.

According to the third embodiment, a single sheet pressing member 50 extends from one end portion to the other end portion in the width direction of the discharge port 14. Accordingly, the sheet P may be stably guided to the discharge tray 13. The first embodiment discloses a plurality of sheet pressing members 50, the third embodiment discloses only a single sheet pressing member 50, and the other points are the same in the first embodiment and the third embodiment.

### Fourth Embodiment

In the first to the third embodiments, the sheet pressing member 50 for guiding the sheet P onto the discharge tray 13 is required. In the fourth embodiment, a guide member that can be replaced with the sheet pressing member 50 is proposed.

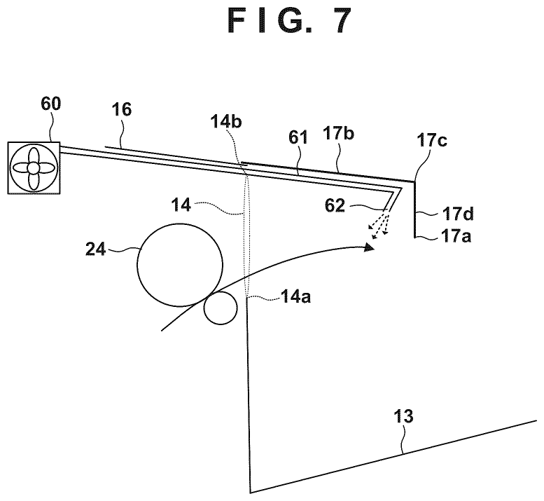

FIG. 7 shows a guide member 61 of the fourth embodiment. A guide member 61 is an air guide pipe (air passage) extending from an air discharge surface of the fan 60 to a lower surface side of the cave member 17. The guide member 61 guides a part of the airflow (airflow) generated by the fan 60 to the lower surface side of the cave member 17. The sheet P is pressed toward the discharge tray 13 by the air blown out from a blowout port 62 of the guide member 61. Accordingly, it improves the alignment accuracy and stackability of the sheets on the discharge tray 13.

Note that the relationship between the leading end 17a of the cave member 17 and the lower edge 14a of the discharge port 14 satisfies the condition described in the first embodiment. That is, the wall member 17d protrudes downward so that the straight line F passing through the leading end 17a and the lower edge 14a passes above the photosensitive member 31. That is, the wall member 17d of the fourth embodiment also serves as the light shielding wall described in the first embodiment.

The first pressing member 50L and the second pressing member 50R shown in FIG. 1 may be replaced with two blowout ports 62 (a first blowout port and a second blowout port). That is, the first blowout port may be disposed at one end portion in a width direction of the discharge port 14 perpendicular to a sheet discharge direction A1. The second blowout port may be disposed at the other end portion in the width direction.

According to the fourth embodiment, a blowout port 62 for blowing air onto the surface of the sheet P is employed so as to guide the sheet P discharged from the discharge port 14 to the discharge tray 13. Accordingly, it makes it possible to omit the sheet pressing member 50. Since the sheet pressing member 50 is not present, the user does not touch the sheet pressing member 50. In addition, the blowout port 62 can guide the sheet P that is to be directed toward the wall member 17d across the space 17e to the discharge tray 13. As the sheet P is appropriately guided, the sheet P is prevented from being caught by the wall member 17d.

A single blowout port 62 may be provided at the central of the discharge port 14 in the width direction. As shown in FIG. 6, a single blowout port 62 that may cover substantially the entire width direction of the discharge port 14 may be employed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-173480, filed Oct. 2, 2024, which is hereby incorporated by reference herein in its entirety.

1. An image forming apparatus comprising:
a photosensitive member that is rotationally driven;
a charging unit that charges a surface of the photosensitive member;
a light irradiation unit that irradiates the photosensitive member with light to form an electrostatic latent image;
a developing unit that develops the electrostatic latent image using toner to generate a toner image;
a transfer unit that transfers the toner image from the photosensitive member to a sheet;
a fixing unit that fixes the toner image onto the sheet;
a discharge unit that discharges the sheet from a discharge port;
a holding unit that holds the sheet discharged from the discharge port;
a cover unit provided above the discharge port and protruding so as to cover a part of the holding unit; and
a guide unit that includes a bending point and guides the sheet discharged from the discharge port to the holding unit,
wherein the cover unit includes:
a connecting portion;
a ceiling surface protruding toward the connecting portion from above the discharge port; and
a wall surface protruding from the connecting portion so as to approach the holding unit,
wherein the photosensitive member is disposed below a straight line passing through a lower end of the wall surface and a lower edge of the discharge port, and
a distance from the bending point of the guide unit to a leading end of the guide unit is longer than a distance from the bending point to the lower end of the wall surface of the cover unit.

2. The image forming apparatus according to claim 1, wherein the cover unit includes a reduction unit that reduces external light entering from the discharge port and going to the photosensitive member.

3. The image forming apparatus according to claim 1, wherein the guide unit includes:
a fixing part that is fixed to an upper surface member of the image forming apparatus; and
a movable portion connected to the fixing part at the bending point, and that rotates about the bending point as a rotation axis, or moves away from the discharge port by the sheet discharged from the discharge port, and returns to a standby position when the sheet is separated from the leading end of the guide unit.

4. The image forming apparatus according to claim 1, wherein there is a space below the ceiling surface and on the side of the wall surface, and
the guide unit guides the sheet to be directed to the wall surface through the space to the holding unit.

5. The image forming apparatus according to claim 1, wherein a thickness and a hardness of the guide unit are a thickness and a hardness that allow the guide unit to bend upon the sheet coming into contact with the guide unit.

6. The image forming apparatus according to claim 1, wherein the guide unit bends until the guide unit comes into contact with a lower end of the wall surface by the sheet coming into contact with the guide unit.

7. The image forming apparatus according to claim 1, wherein a basis weight of the sheet is equal to or greater than 60 g/m² and equal to or less than 220 g/m².

8. The image forming apparatus according to claim 1, wherein a thickness of the sheet is equal to or greater than 0.05 mm and equal to or less than 0.3 mm.

9. The image forming apparatus according to claim 1, wherein the guide unit includes at least one pressing member that presses the sheet discharged from the discharge port.

10. The image forming apparatus according to claim 9, wherein the at least one pressing member includes a first pressing member and a second pressing member,
the first pressing member is disposed at one end portion in a width direction of the discharge port perpendicular to a discharge direction of the sheet, and
the second pressing member is disposed at another end portion in the width direction.

11. The image forming apparatus according to claim 9, wherein the at least one pressing member includes a single pressing member, and
the single pressing member extends from one end portion to another end portion in a width direction of the discharge port perpendicular to a discharge direction of the sheet.

12. An image forming apparatus comprising:
a photosensitive member that is rotationally driven;
a charging unit that charges a surface of the photosensitive member;
a light irradiation unit that irradiates the photosensitive member with light to form an electrostatic latent image;
a developing unit that develops the electrostatic latent image using toner to generate a toner image;
a transfer unit that transfers the toner image from the photosensitive member to a sheet;
a fixing unit that fixes the toner image onto the sheet;
a discharge unit that discharges the sheet from a discharge port;
a holding unit that holds the sheet discharged from the discharge port; and
a cover unit provided above the discharge port and protruding so as to cover a part of the holding unit,
wherein the cover unit includes:
a connecting portion;
a ceiling surface protruding toward the connecting portion from above the discharge port;
a wall surface protruding from the connecting portion so as to approach the holding unit; and
a lower surface that is connected to a lower end of the wall surface and guides the sheet discharged from the discharge port to the holding unit.

13. The image forming apparatus according to claim 12, wherein the lower surface of the cover unit is connected to an upper edge of the discharge port or to the ceiling surface.

14. An image forming apparatus comprising:
a photosensitive member that is rotationally driven;
a charging unit that charges a surface of the photosensitive member;
a light irradiation unit that irradiates the photosensitive member with light to form an electrostatic latent image;
a developing unit that develops the electrostatic latent image using toner to generate a toner image;
a transfer unit that transfers the toner image from the photosensitive member to a sheet;
a fixing unit that fixes the toner image onto the sheet;
a discharge unit that discharges the sheet from a discharge port;
a holding unit that holds the sheet discharged from the discharge port; and
a cover unit provided above the discharge port and protruding so as to cover a part of the holding unit,
wherein the cover unit includes:
a connecting portion;
a ceiling surface protruding toward the connecting portion from above the discharge port; and
a wall surface protruding from the connecting portion so as to approach the holding unit; and
a blowing unit that blows air to a surface of the sheet so as to guide the sheet discharged from the discharge port to the holding unit.

15. The image forming apparatus according to claim 14, further comprising a fan that cools the image forming apparatus; and
an air passage that guides an airflow generated by the fan to the blowing unit.

16. The image forming apparatus according to claim 14, wherein the blowing unit has a first blowout port and a second blowout port,
the first blowout port is disposed at one end portion in a width direction of the discharge port perpendicular to a discharge direction of the sheet, and
the second blowout port is disposed at another end portion in the width direction.

17. An image forming apparatus comprising:
a photosensitive member that is rotationally driven;
a charging member that charges a surface of the photosensitive member;
a light source that irradiates the photosensitive member with light to form an electrostatic latent image;
a developing member that develops the electrostatic latent image using toner to generate a toner image;
a transfer member that transfers the toner image from the photosensitive member to a sheet;
a fixing member that fixes the toner image onto the sheet;
a discharge roller pair that discharges the sheet from a discharge port;
a tray that holds the sheet discharged from the discharge port;
an eave member provided above the discharge port and protruding so as to cover a part of the tray; and
a pressing member that includes a bending point and guides the sheet to the tray by pressing the sheet discharged from the discharge port,
wherein the eave member includes:
a connecting portion;
a roof part protruding toward the connecting portion from above the discharge port; and
a wall part protruding from the connecting portion so as to approach the tray,
wherein the photosensitive member is disposed below a straight line passing through a lower end of the wall part and a lower edge of the discharge port, and
a distance from the bending point of the pressing member to a leading end of the pressing member is longer than a distance from the bending point to the lower end of the wall part.
